(19) United States
(12) Patent Application Publication
(10) Pub. No.: US 2014/0222877 A1
(43) Pub. Date: Aug. 7, 2014

(54) Method of capturing data for a portable mobile device

(71) Applicant: InfoPower Corporation, Taipei (TW)

(72) Inventors: Jer-Bin Lin, New Taipei City (TW); Che-Yu Lee, New Taipei City (TW); Chun-Lin Chen, Tainan City (TW)

(73) Assignee: InfoPower Corporation, Taipei (TW)

(21) Appl. No.: 14/174,817

(22) Filed: Feb. 6, 2014

Related U.S. Application Data
(60) Provisional application No. 61/762,292, filed on Feb. 7, 2013.
(60) Provisional application No. 61/807,777, filed on Apr. 3, 2013.

(51) Int. Cl. G06F 17/30

(52) U.S. Cl. CPC G06F 17/3007
USPC 707/822

(57) ABSTRACT

A method for data capturing that links a portable device to a source and displays file content of a file from the source. At least a portion of the file content of the file is selected and saved together with a source address of the file under a sub-category of a category.

### CROSS REFERENCE TO RELATED APPLICATIONS

This non-provisional application claims priority of U.S. provisional application U.S. 61/762,292 filed on Feb. 7, 2013 and U.S. provisional application U.S. 61/807,777 filed on Apr. 3, 2013.

### BACKGROUND OF THE INVENTION

1. Field of the Invention

The present invention relates to a method of capturing data for a portable mobile device, and more particularly, a method of data capturing of a portion of a file content of a file from a source and a method of selecting and opening of captured data.

2. Description of the Prior Art

When preparing documents or articles, users usually browse through sources from the internet and retrieve relevant contents such as figures, text and documents from the sources. Though, the current applications in computers allow users easy capturing of the relevant contents, users are still tasked to take separate note of the source of the relevant contents. The users are tasked to create their own filing system that would allow them to organize and match the noted sources with the relevant contents that they have saved. Such tracking is very time consuming and unreliable. And since the noted source is saved separately form the relevant contents; there is no guarantee that all relevant contents saved can be properly matched to the source when required. This is especially difficult to deal with when publishing articles that require referencing of the contents of the article.

### SUMMARY OF THE INVENTION

An embodiment of the present invention discloses a method of data capturing. The method of data capturing comprises installing and running a file management program on a mobile device, linking the mobile device to a source, displaying a file content of a file from the source on a first user interface of the file management program, displaying a plurality of categories and at least one sub-category of one of the plurality of categories on a second user interface of the file management program, and adding the source address and at least a portion of the file content of the file to a sub-category of one of the plurality of categories or a new sub-category of a new category as a new content. The file content does not include a source address of the file.

Another embodiment of the present invention discloses a method of selecting and opening of captured data. The method of selecting and opening of captured data comprises installing and running a file management program on a mobile device; displaying a plurality of categories, at least one sub-category of one of the categories, and thumbnails of at least one new content of one of the at least one sub-category on a user interface the file management program; selecting a new content from the at least one new content; and displaying the new content. The new content comprises a source address of a file from a source, and at least a portion of a file content of the file

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a first interface of a user interface of the file management program on a mobile device according to an embodiment of the present invention.

FIG. 2 illustrates a second interface of the user interface of the file management program on the mobile device in FIG. 1.

FIG. 3 illustrates a third interface of the user interface of the file management program on the mobile device in FIG. 1.

FIG. 4 illustrates a fourth interface of the user interface of the file management program on the mobile device in FIG. 1.

FIG. 5 illustrates the third interface of the user interface when selecting a link.

FIG. 6 illustrates the third interface of the user interface when selecting a chain of text.

FIG. 7 illustrates a fifth interface of the user interface of the file management program on the mobile device in FIG. 1.

FIG. 8 illustrates a flowchart of a data capturing method of the file management program according to the present invention.

FIG. 9 illustrates a flowchart of a method of selecting and opening of captured data of the file management program according to the present invention.

### DETAILED DESCRIPTION

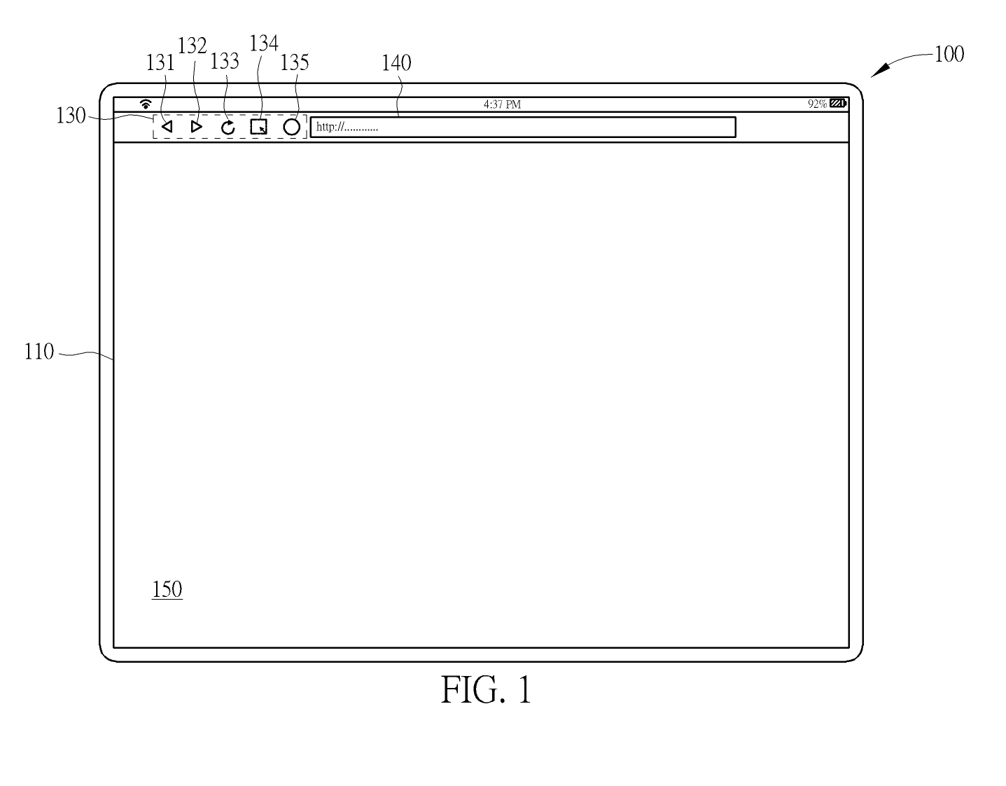

Please refer to FIG. 1. FIG. 1 illustrates a first interface of a user interface 110 of the file management program on a mobile device 100 according to an embodiment of the present invention. The first interface of the user interface 110 comprises a tool bar 130, a textbox 140, and a display window 150. The tool bar 130 comprises but is not limited to tool icons 131 to 135. The textbox 140 is used to enter a source address of a source. The source address may be a universal resource locator (URL). When the source address is entered to the textbox 140, the file management program will link the mobile device 100 to the source. The source may comprise one file or a combination of files. The file may be a text file, an image file, a database file, a presentation file or a multimedia file. The display window 150 is used to display file content of the file from the source. If the display window 150 is not capable of displaying the whole file content, a user may slide or drag through the preview window to show other parts of the file content. Selecting the tool icon 131 would have the file management program link to a previous source that was previously linked to. And Selecting of the tool icon 132 would have the file management program link to the source that the mobile device 100 linked to after the previous source. Selecting of the tool icon 133 would have the file management program to link again to the source and refresh the file content of the file shown in the preview window 150. Selecting the tool icon 134 would show a second interface of the user interface 110. Selecting and dragging the tool icon 135 would show a third interface of the user interface 110.

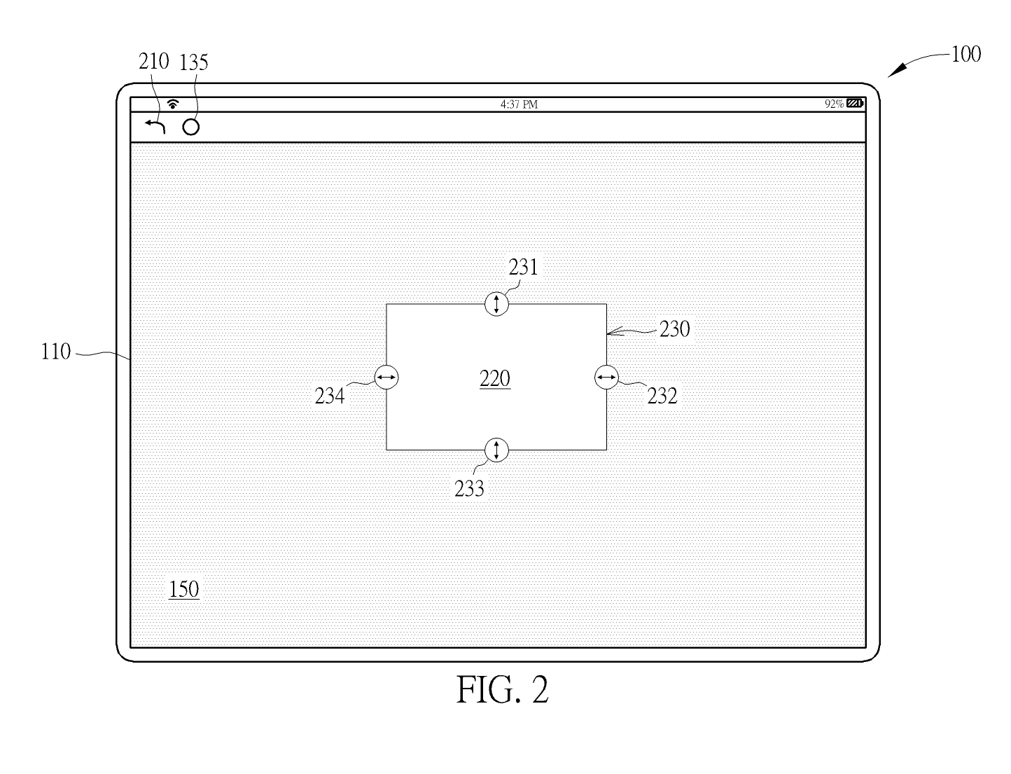

Please refer to FIG. 2. FIG. 2 illustrates the second interface of the user interface 110 of the file management program on the mobile device 100 in FIG. 1. The second interface of the user interface 110 comprises the tool icon 135, a return icon 210, a select window 220, the display window 150, and a select box 230. The select window 220 is placed in front of the display window 150. Size of the select window 220 is defined by the select box 230. The select box 230 comprises expand icons 231 to 234. The expand icons 231 to 234 allow the user to adjust the dimension of the select box 230. The select window 220 selects at least a portion of the file content displayed in the display window 150. Portion of the display window 150 outside the select window 220 is shaded to allow user to easily view and distinguish the at least a portion of the file content selected. When the return icon 210 is selected, the file management program will return to the first interface of the user interface 110. When the tool icon 135 is selected, the file management program would show a fourth interface of the user interface 110. To terminate the selecting process, the return icon 210 may be selected to return to the first interface.

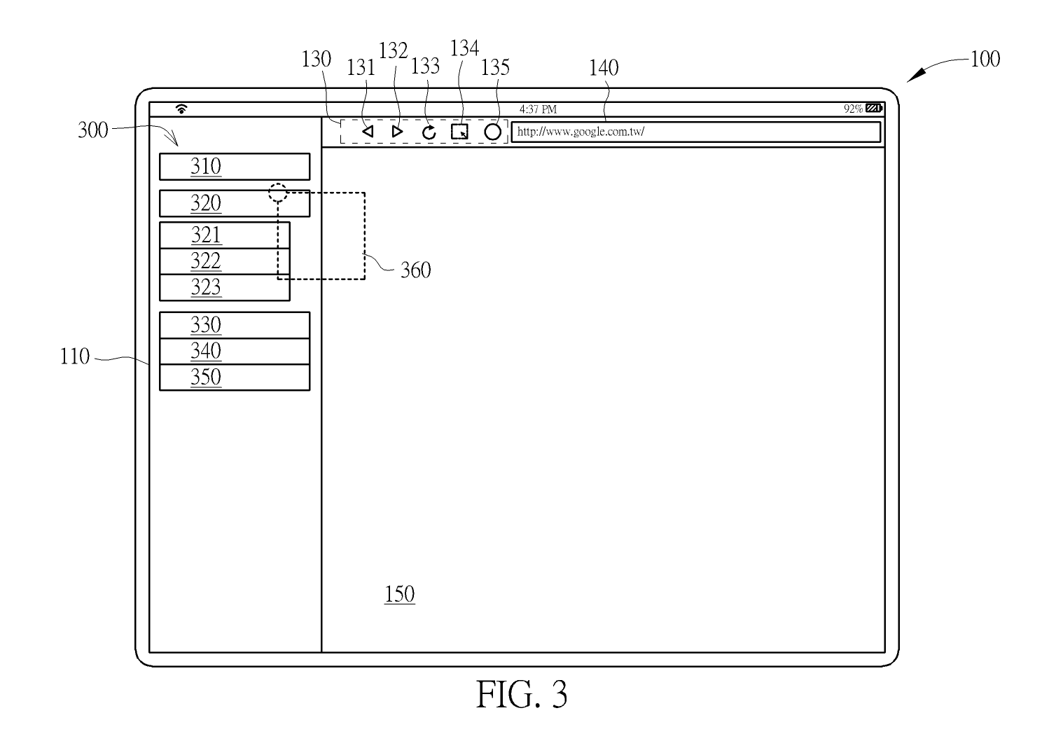

Please refer to FIG. 3. FIG. 3 illustrates the third interface of the user interface 110 of the file management program on the mobile device 100 in FIG. 1. The third interface of the user interface 110 may comprise objects from the first interface and a sidebar 300. The sidebar 300 may include an add category option 310, a plurality of categories 320 to 350, and a plurality of sub-categories 321 to 323 of a category 320. When the tool icon 135 is selected in the first interface, the sidebar 300 will appear. The source address of the file is the source address that was entered in the textbox 140. The file content to be saved is copied from the source. The file management program will generate a symbolic image 360 of the file content to be saved. The symbolic image 360 may then be dragged above one of the plurality of categories 320 to 350. Sub-categories of a category selected shall be displayed. In FIG. 3, the symbolic image 360 is dragged over the category 320. And the plurality of sub-categories 321 to 323 of the category 320 is displayed. The symbolic image 360 may be further dragged over a sub-category to save the file content to the sub-category as a new content of the sub-category. If the symbolic image 360 is dragged over the sub-category 321, a copy of the file content and the source address of the file shall be saved as a new content of the sub-category 321. The filename of the new content may be user defined or generated by the file management program according to name of original file, date of creation, or generic name programmed into the file management program.

If the file content is saved from the first interface, the entirety of the file and the source address of the file shall be copied and saved by the file management program to a memory accessible to the file management program. The memory accessible to the file management program may be a cloud memory, an external memory or internal memory of the portable device 100. The file may be saved in the memory under the same file type as the file type from the source. The file type may be a text file, image file, database file, presentation file or multimedia file.

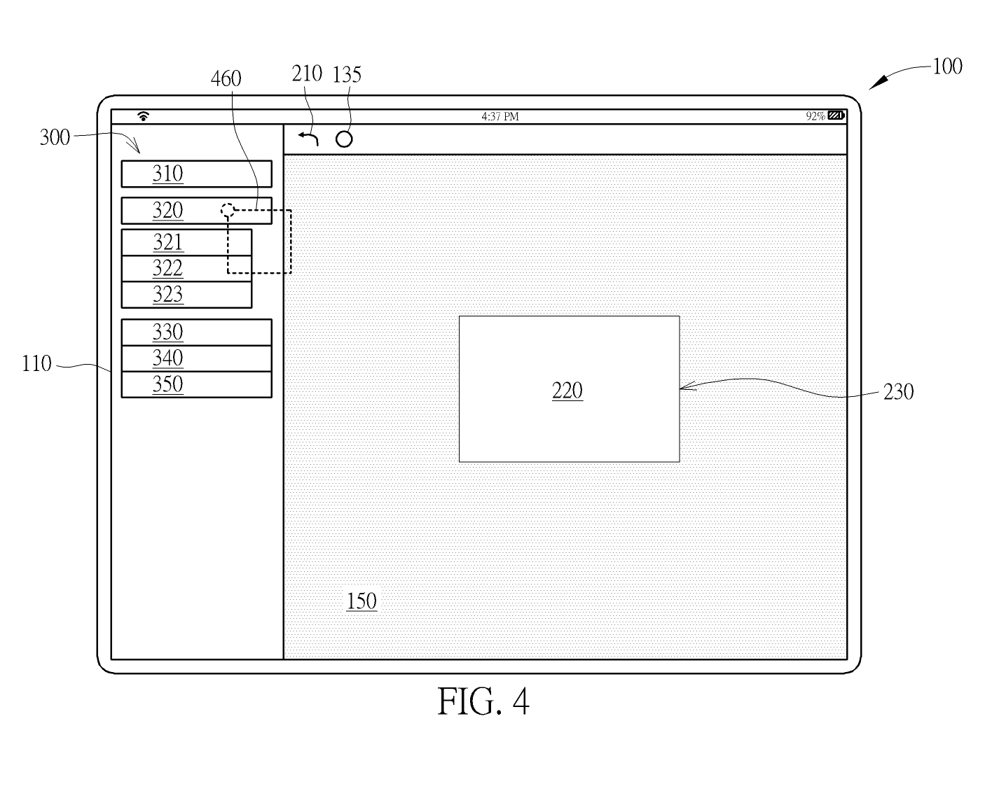

Please refer to FIG. 4. FIG. 4 illustrates the fourth interface of the user interface 110 of the file management program on the mobile device 100 in FIG. 1. The fourth interface of the user interface 110 may comprise objects from the second interface and the sidebar 300. When the tool icon 135 is selected in the second interface, the sidebar 300 will appear. The source address of the file is the source address that was entered in the textbox 140 of the first interface. The file management program will generate a symbolic image 460 of the file content selected using the select window 220. The file content within the select window 220 is copied. The file content selected using the select window 220 may be saved as an image file. The symbolic image 460 may then be dragged above one of the plurality of categories 320 to 350. Sub-categories of a category selected shall be displayed. In FIG. 4, the symbolic image 460 is dragged over the category 320. And the plurality of sub-categories 321 to 323 of the category 320 is displayed. The symbolic image 460 may be further dragged over a sub-category to save the file content copied from the file and the source address of the file to the sub-category as a new content of the sub-category. If the symbolic image 460 is dragged over the sub-category 321, the file content shall be saved as a new content of the sub-category 321. The filename of the new content may be user defined or generated by the file management program according to name of original file, date of creation, or generic name programmed into the file management program. The image file containing the file content is saved by the file management program to the memory accessible to the file management program.

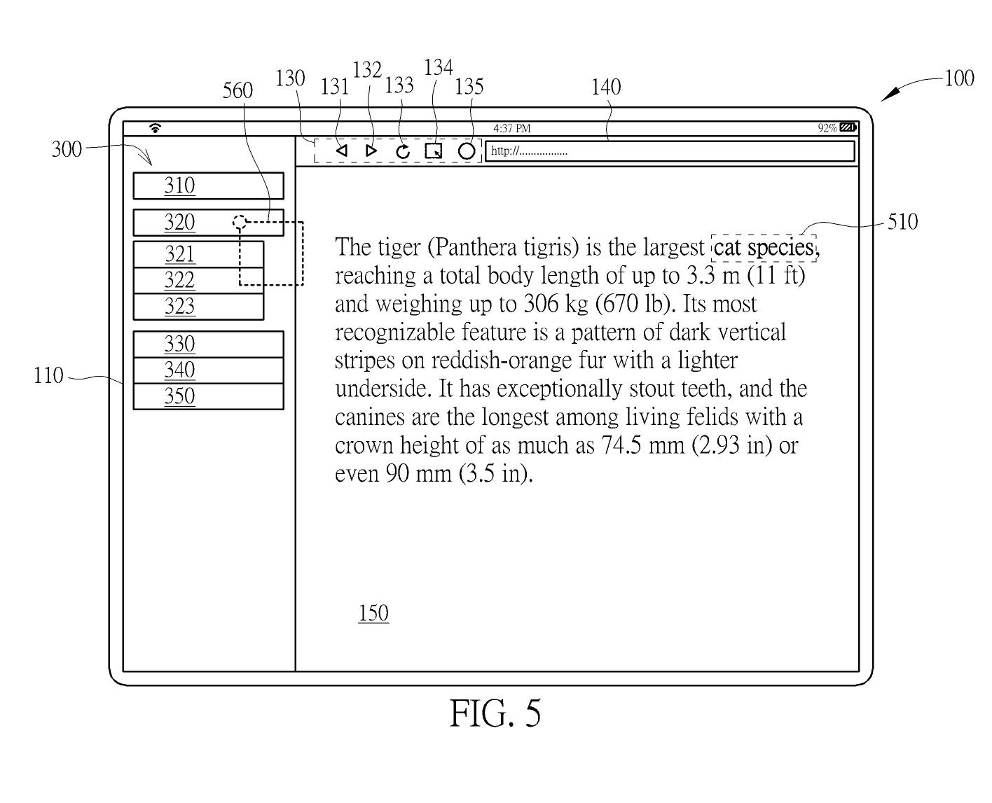

Please refer to FIG. 5. FIG. 5 illustrates the third interface of the user interface 110 when selecting a link 510. When the link 510 is selected from the file content of the file displayed on the display window 150, the sidebar 300 will appear. The file corresponding to the link 510 is copied. The file management program will generate a symbolic image 560 of a file corresponding to the link 510. The link 510 may have an anchor which is the source address of the file corresponding to the link 510. The file corresponding to the link 510 may be a web page, a text file, image file, database file, presentation file or multimedia file. The symbolic image 560 may then be dragged above one of the plurality of categories 320 to 350. Sub-categories of a category selected shall be displayed. In FIG. 5, the symbolic image 560 is dragged over the category 320. And the plurality of sub-categories 321 to 323 of the category 320 is displayed. The symbolic image 560 may be further dragged over a sub-category to save a copy of the file corresponding to the link 510 and the source address of the file to the sub-category as a new content of the sub-category. If the symbolic image 560 is dragged over the sub-category 321, the file corresponding to the link 510 shall be saved as a new content of the sub-category 321. The filename of the new content may be user defined or generated by the file management program according to name of original file, date of creation, or generic name programmed into the file management program. Entirety of the file corresponding to the link 510 is saved by the file management program to the memory accessible to the file management program.

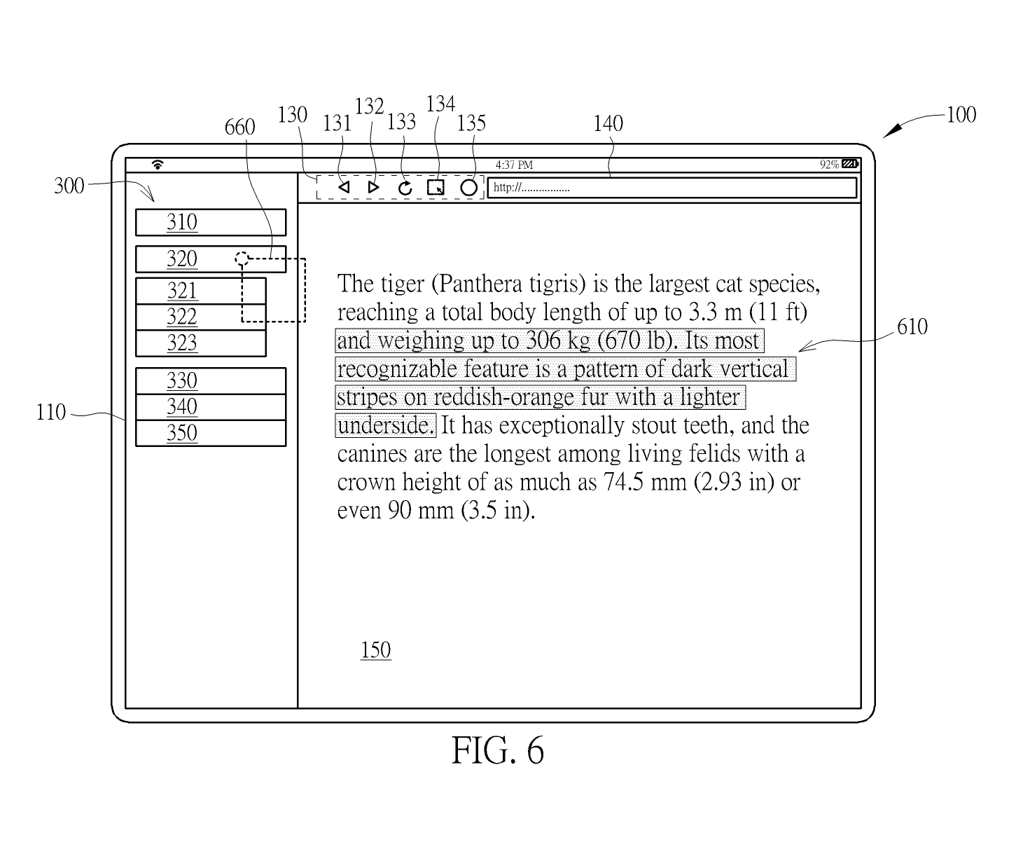

Please refer to FIG. 6. FIG. 6 illustrates the third interface of the user interface 110 when selecting a chain of text 610. The source address of the file is the source address that was entered in the textbox 140 of the first interface. When the chain of text 610 is selected from the file content displayed on the display window 150, the sidebar 300 will appear. The chain of text 610 is copied from the file. The file management program will generate a symbolic image 660 of chain of text 610. The symbolic image 660 may then be dragged above one of the plurality of categories 320 to 350. Sub-categories of a category selected shall be displayed. In FIG. 6, the symbolic image 660 is dragged over the category 320. And the plurality of sub-categories 321 to 323 of the category 320 is displayed. The symbolic image 660 may be further dragged over a sub-category to save the file to the sub-category as a new content of the sub-category. If the symbolic image 660 is dragged over the sub-category 321, the chain of text 610 copied from the file and the source address of the file shall be saved as a new content of the sub-category 321. The chain of text 610 is saved as a text file. The filename of the new content may be user defined or generated by the file management program according to name of original file, date of creation, or generic name programmed into the file management program. The text file containing the chain of text 610 is saved by the file management program to the memory accessible to the file management program.

The chain of text 610 may also be first copied to a notepad. By copying on to the notepad first, the user may edit the chain of text 610 before saving the chain of text 610 as a text file.

For FIG. 3 to FIG. 6, a new category may be created by selecting the add category option 310. A new sub-category under a category or the new category may also be created. And a new content may be saved to the new sub-category by dragging and dropping the symbolic image 360, 460, 560, and 660 over the new sub-category. A new category and a new sub-category of the new category may also be created by dragging and dropping the symbolic image 360, 460, 560, and 660 over the add category option 310.

Using the file management program, the user may select a new content by selecting a thumbnail of the new content from a plurality of thumbnails under a sub-category of a category in a select interface of the user interface 110. When the thumbnail of the new content is selected, the user interface 110 shall display a fifth interface of the user interface 110.

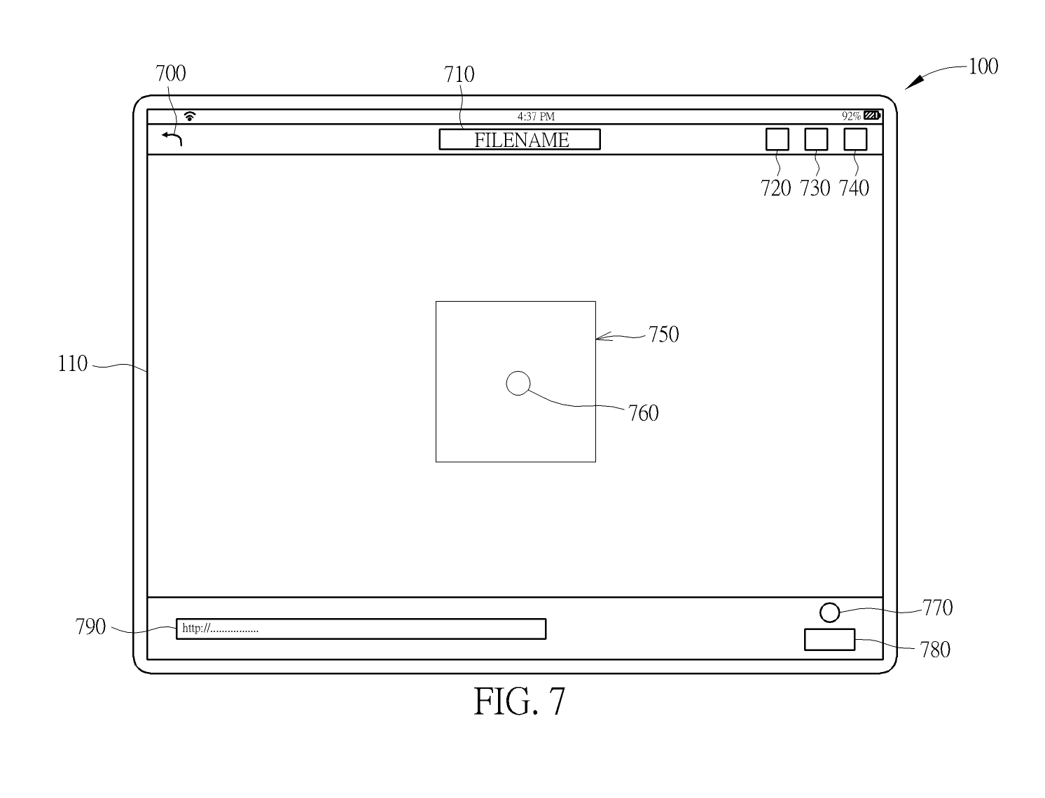

Please refer to FIG. 7. FIG. 7 illustrates the fifth interface of the user interface 110 of the file management program on the mobile device 100 in FIG. 1. The fifth interface of the user interface 110 may comprise a return icon 700, a plurality of labels 710, 780, and 790, a plurality of icons 720 to 740, a symbolic image 750 of the new content, a file link icon 760, and a source link icon 770. The file management program shall return to the select interface of the user interface 110 when the return icon 700 is selected. The label 710 is used to display the filename of the new content. The icon 720 may be a share icon wherein when selected will allow the user to share the new content to another user through networks, e.g. Facebook, Twitter, Gmail, or Hotmail. The icon 730 may be a note icon, wherein when selected will allow the user to add a remark that shall correspond to the new content. When the new content is an image file, the icon 740 may be an edit icon, wherein when selected will allow the user to edit the new content by adding or erasing drawings and/or text in the image file. The symbolic image 750 may be a preview of a portion of the new content or a symbol of the file type of the new content. The file link icon 760 will direct the file management program to open the new content when selected. The source link 770 will direct the file management program to open the source of the new content. The source may be opened using the first interface of the user interface 110. The label 780 is used to display the amount of memory the new content occupies. The label 790 is used to display the address of the source of the file content saved as the new content. The source address in the label 790 is a source address entered in the textbox 140 unless the new content is saved through a link. In the case of the link, the source address from the anchor of the link shall be shown in the label 790.

On the fifth interface of the user interface 110, user may go through the plurality of new contents by dragging through the user interface 110. The fifth interface will display the new content sequentially in front or behind the new content currently displayed depending on the dragging direction.

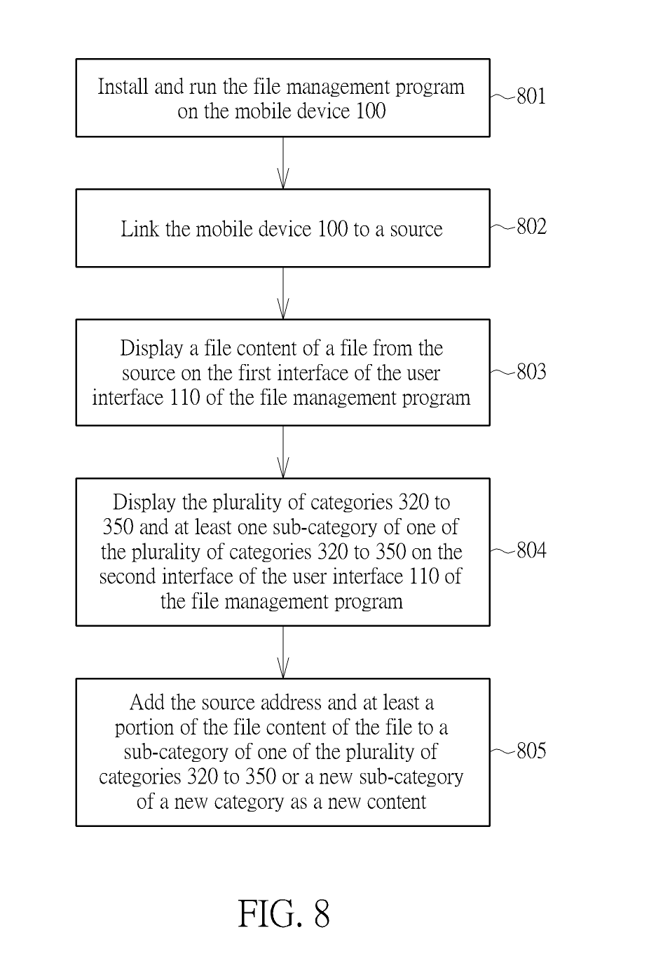

Please refer to FIG. 8. FIG. 8 illustrates a flowchart of a data capturing method of the file management program according to the present invention. As shown in FIG. 8, the data capturing method may include and is not limited to the following steps:
Step 801: Install and run the file management program on the mobile device 100;
Step 802: Link the mobile device 100 to a source;
Step 803: Display a file content of a file from the source on the first interface of the user interface 110 of the file management program;
Step 804: Display the plurality of categories 320 to 350 and at least one sub-category of one of the plurality of categories 320 to 350 on the second interface of the user interface 110 of the file management program; and
Step 805: Add the source address and at least a portion of the file content of the file to a sub-category of one of the plurality of categories 320 to 350 or a new sub-category of a new category as a new content.

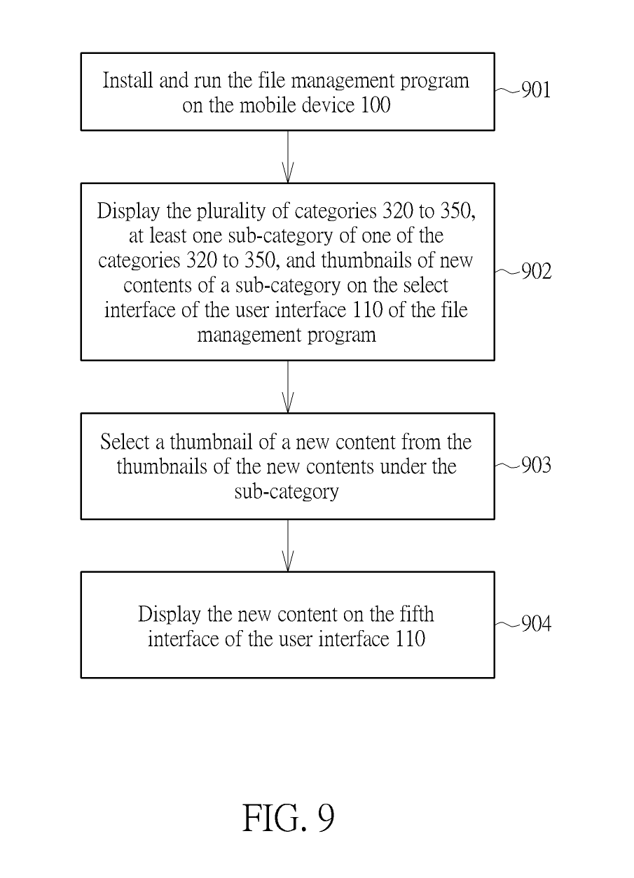

Please refer to FIG. 9. FIG. 9 illustrates a flowchart of a method of selecting and opening of captured data of the file management program according to the present invention. As shown in FIG. 9, the method of selecting and opening of captured data may include and is not limited to the following steps:
Step 901: Install and run the file management program on the mobile device 100;
Step 902: Display the plurality of categories 320 to 350, at least one sub-category of one of the categories 320 to 350, and thumbnails of new contents of a sub-category on the select interface of the user interface 110 of the file management program;
Step 903: Select a thumbnail of a new content from the thumbnails of the new contents under the sub-category; and
Step 904: Display the new content on the fifth interface of the user interface 110.

The data capturing method would allow user to have convenience to save a file content of a file together with the source address of the file. The file contents saved may be the entirety of the file or a portion of the file content of the file. Since the source address of the file content is saved together with the file content under a new content of a sub-category, referencing of the file content would be convenient. The source link icon 770 in the fifth interface would also allow user to easily access and link to the source of the file content. When accessing the file content from the file saved by the file management program by selecting the thumbnail of the corresponding new content, the file management program is not limited to opening the new content using the fifth interface of the user interface 110. When a thumbnail of a multimedia file is selected, the file management program may automatically play the multimedia file by linking to the source but without displaying other parts of the file from the source. For example, if a multimedia file from a web page is selected and saved, when accessing the saved multimedia file using the file management program, the entirety of the display of the portable device may be used to play the multimedia file and other parts of the web page, such as text and image, are no longer displayed. The multimedia file may also be played in the fifth interface by replacing the symbolic image with a preview window. When the new content selected is a web page, the file management program may automatically go to the first interface of the user interface 110 to display the web page.

The number of categories, sub-categories and new contents that the file management program can create, edit and save are not limited to the number described in this article. It is only an example to illustrate the aspect of the present invention for clarity and not intended to limit the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of data capturing, comprising:
installing and running a file management program on a mobile device;
linking the mobile device to a source;
displaying a file content of a file from the source on a first user interface of the file management program, wherein the file content does not include a source address of the file;
displaying a plurality of categories and at least one sub-category of one of the plurality of categories on a second user interface of the file management program; and
adding the source address and at least a portion of the file content of the file to a sub-category of one of the plurality of categories or a new sub-category of a new category as a new content.

2. The method of claim 1, further comprising dragging and dropping the at least a portion of the file content of the file to the sub-category of one of the plurality of categories or the new sub-category of the new category.

3. The method of claim 1, wherein the new content further comprises a symbolic image of the at least a portion of the file content, and a filename of the new content.

4. The method of claim 3, wherein the new content further comprises a file size of the at least a portion of the file content.

5. The method of claim 3, wherein the new content further comprises a source link icon and a file link icon.

6. The method of claim 3, wherein the file has a predetermined file type.

7. The method of claim 6, wherein the symbolic image is generated by the file management program according to the predetermined file type of the file.

8. The method of claim 6, wherein the file is a text file, image file, database file, presentation file or multimedia file.

9. The method of claim 3, wherein the file is a web page.

10. The method of claim 9, wherein the at least a portion of the file content is added to the sub-category or the new sub-category as a text file, image file, database file, presentation file or multimedia file.

11. A method of selecting and opening of captured data, comprising:
installing and running a file management program on a mobile device;
displaying a plurality of categories, at least one sub-category of one of the categories, and thumbnails of at least one new content of one of the at least one sub-category on a user interface of the file management program;
selecting a new content from the at least one new content; and
displaying the new content;
wherein the new content comprises a source address of a file from a source, and at least a portion of a file content of the file.

12. The method of claim 11, wherein the new content further comprises a symbolic image of the at least a portion of the file content, and a filename of the new content.

13. The method of claim 12, wherein the new content further comprises a file size of the data.

14. The method of claim 12, wherein the new content further comprises a source link icon and a file link icon.

15. The method of claim 14, further comprising displaying the file content of the file from the source on another user interface when the source link icon is selected.

16. The method of claim 14, further comprising displaying the at least a portion of the file content when the file link icon is selected.

17. The method of claim 16, further comprising:
editing the at least a portion of the file content after the at least a portion of the file content is displayed; and
saving the at least a portion of the file content after the at least a portion of the file content is edited.

18. The method of claim 11, wherein the at least a portion of the file content is a selected part of a web page.
